(19) United States
(12) Patent Application Publication
(10) Pub. No.: US 2008/0260333 A1
(43) Pub. Date: Oct. 23, 2008

(54) REPLACEMENT OPTICAL CONNECTOR

(76) Inventor: Richard F. Roth, Brookline, NH (US)

Correspondence Address: BLANK ROME LLP, 600 NEW HAMPSHIRE AVENUE, N.W., WASHINGTON, DC, 20037, US

(21) Appl. No.: 12/107,831

(22) Filed: Apr. 23, 2008

Related U.S. Application Data
(60) Provisional application No. 60/913,441, filed on Apr. 23, 2007.

(51) Int. Cl. G02B 6/38

(52) U.S. Cl. 385/72

(57) ABSTRACT

A first mating unit for engaging a second mating unit of an optical connector is described. The first mating unit includes a connector sleeve, a connector housing connected to one end of the connector sleeve, and a ferrule carrier inserted into the connector sleeve opposite the connector housing. The connector housing is substantially shaped to mate with the second mating unit. The ferrule carrier is removably engaged to the connector sleeve and adapted to connect with an optical fiber cable.

### CROSS REFERENCE TO RELATED APPLICATION

This application claims benefit of priority to U.S. provisional patent application Ser. No. 60/913,441, entitled “Replacement Optical Connector,” filed Apr. 23, 2007, the entire disclosure of which is incorporated herein by reference.

### FIELD OF THE INVENTION

The present invention relates to optical connectors. In particular, the present invention relates to replacement optical connectors that include a removable ferrule carrier and generally conforms to the design of a previously installed connector.

### BACKGROUND OF THE INVENTION

For transferring data, fiber optic cables have many advantages over conductive cables. First, fiber optic cables can be lighter and smaller than conductive metal cables. Another advantage of fiber optic cables is that they transmit data by using light signals instead of electrical signals. By using light signals, fiber optic cables have less attenuation, more data capacity, and greater immunity to noise and interference than conductive cables. Light signals traveling through fiber optic cables can be of higher frequency and suffer less attenuation than electrical signals of the same frequency in conductive cables. The higher frequency light signals in fiber optic cables also have a greater data transmission capacity than comparable conductive cables. Further, fiber optic cables are typically made of nonconductive materials, such as plastic or glass, which are immune to electromagnetic interference or noise from lightning or radio waves.

To connect fiber optic cables, optical connectors and ferrules are used. Within optical connectors are ferrules which provide the termini for connection. The optical fibers of fiber optic cables are inserted into ferrules which are placed within the optical connector. After an outer jacket of the fiber optic cable has been stripped and the underlying optical fibers have been exposed, the end of each optical fiber is inserted through a bore in the ferrule and trimmed generally flush with a mating surface of the ferrule. The mating surface of the ferrule is then polished so that the end of the optical fiber is coplanar with the mating surface of the ferrule. The ferrule can then be placed directly in the optical connector. Alternatively, the ferrule can be placed on a ferrule carrier which is then placed in the optical connector. One particular type of ferrule carrier is designated “mechanical transfer” or MT ferrule carrier.

The ferrule carrier may be designed for later removal from the optical connector, such as the ferrule carrier described in U.S. Pat. No. 7,204,016 (“the '016 patent”) to Roth et al., entitled “Ferrule Assembly and Methods Therefor,” filed Dec. 20, 2002, which is incorporated herein by reference in its entirety. The '016 patent describes a ferrule assembly that can be inserted into an optical connector and that provides for terminating optical fibers of a ribbon cable. The ferrule assembly has a ferrule with a mating face, an alignment member, a latch for engaging a slot provided on the optical connector housing, and a flexible grip upon which the latch is disposed.

To facilitate and promote interoperability, standards governing connector design have been devised. One standard connector design is “multi-fiber push on” or “MPO.” MPO connectors meet the standards of IEC-61754-7, an international standard, and TIA-604-5, a United States standard which is also known as FOCIS 5. One improved MPO connector design is the “mechanical transfer push/pull,” also known as an MTP connector.

Presently, MTP connectors are widely used to connect fiber optic cables. However, MTP connectors do not accept ferrule carriers. Thus, if an optical connector with a ferrule carrier is desired, previously installed MTP connectors have to be replaced. Since MTP connectors are already extensively installed, it is difficult and costly to replace all installed MTP connectors. Also, if one of the internal components of an MTP connector needs to be repaired or if one of the internal components is to be modernized with a more advanced version, the entire MTP connector must be replaced. For example, if one of the optical fibers internal to the MTP connector is damaged, the entire MTP connector must be replaced.

### SUMMARY OF THE INVENTION

Accordingly, it is an object of the present invention to provide a replacement optical connector that accepts ferrule carriers. It is another object of the present invention to provide a replacement connector that generally conforms to the design of a previously installed optical connector.

One embodiment of the present invention provides a first mating unit for engaging a second mating unit of an optical connector. The first mating unit includes a connector sleeve, a connector housing connected to one end of the connector sleeve, and a ferrule carrier inserted into the connector sleeve opposite the connector housing. The connector housing is substantially shaped to mate with the second mating unit. The ferrule carrier is removably engaged to the connector sleeve and adapted to connect with an optical fiber cable.

Another embodiment of the present invention provides a first mating unit for engaging a second mating unit of an optical connector. The first mating unit includes a connector sleeve with a slot, a connector housing connected to one end of the connector sleeve, a ferrule carrier inserted into the connector sleeve opposite the connector housing, and a latch on the ferrule carrier. The connector housing substantially conforms to an MTP connector plug. The ferrule carrier is adapted to connect with an optical fiber cable, and the latch on the ferrule carrier removably engages the slot of the connector sleeve.

Yet another embodiment of the present invention provides an optical connector. The optical connector includes a connector sleeve formed together with a connector housing and a ferrule carrier inserted into the connector sleeve opposite the connector housing. The connector housing has a shape substantially conforming to a plug of a previously installed optical connector and is received by the receptacle for the previously installed optical connector. The ferrule carrier is adapted to couple with an optical fiber cable.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an assembled optical connector according to an exemplary embodiment of the present invention;

FIG. 2 is an exploded perspective view of the optical connector illustrated in FIG. 1;

FIG. 3 is a perspective view of one end of a connector sleeve of the optical connector illustrated in FIG. 1;

FIG. 4 is a perspective view of an opposite end of the connector sleeve illustrated in FIG. 3;

FIG. 5 is a perspective view of the connector sleeve coupled to a connector housing of the optical connector illustrated in FIG. 1;

FIG. 6 is a perspective view of a ferrule carrier of an optical connector according to another embodiment of the present invention; and

FIG. 7 is a perspective view of the assembled optical connector with the ferrule carrier illustrated in FIG. 6.

### DETAILED DESCRIPTION OF THE INVENTION

The present invention relates to an optical connector. The optical connector has a first mating unit that engages a second mating unit. At least one of the mating units of the optical connector has a connector sleeve 100 for use with a connector housing 200 and a ferrule carrier 300. The connector housing 200 conforms to the design of a previously installed optical connector. For example, the connector housing 200 can substantially conform to a previously installed optical connector plug or receptacle, such as an MTP or MPO plug or receptacle. The connector sleeve 100 combined with the connector housing 200 provides a replacement connector that can accept a ferrule carrier 300. The connector sleeve 100 also allows replacement of fiber optic cables without replacing the entire mating unit 10 because the housing 200 does not need to be replaced. Finally, since the connector housing 200 conforms to the design of the previously installed optical connector, the mating unit 10 can be examined and tested by inspection equipment designed for the previously installed optical connector.

To simplify the description of the invention, the connector housing 200 is described as conforming to the shape of a plug of an optical connector. In other embodiments, the connector housing 200 can conform to the shape of a receptacle of the optical connector. Also, in the describing the present invention, terms such as “front,” “rear,” “rearward,” “forward,” “up,” “down,” “upward,” “downward,” and similar terms are used only to facilitate the description of the invention. The terms are used to specify the location of one component with respect to another with the forward, rear, up, and down directions arbitrarily selected. Such terms are not meant to be limiting.

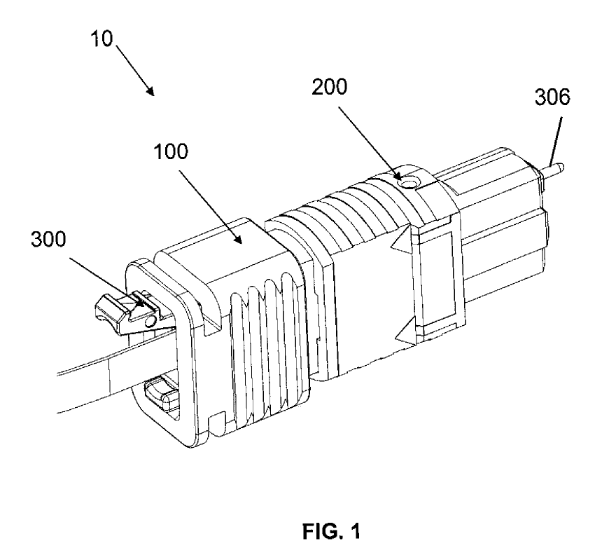

Referring to FIG. 1, an assembled mating unit 10 is shown. The mating unit 10 includes the connector sleeve 100, the connector housing 200 coupled to one end of the connector sleeve 100, and the ferrule carrier 300 that is received at the opposite end of the connector sleeve 100. With the connector housing 200 coupled to one end of the connector sleeve 100, the ferrule carrier 300 is inserted into the opposite end of the connector sleeve 100 and extends through the connector sleeve 200 to be substantially received in the connector housing 200. The ferrule carrier 300 extends fully through the connector sleeve 100. The forward end of the ferrule carrier 300 passes through the connector sleeve 100 and into the connector housing 200. A multi-fiber ferrule 306 at the forward end of the ferrule carrier 300 extends out of the forward end of the connector housing 200 so that the ferrule 306 can mate with its counterpart. The connector housing 200 conforms to the design of a previously installed optical connector. Thus, the connector housing 200 has a shape that can be accepted by the previously installed optical connector's receptacle (not shown). In the embodiment depicted, the connector housing 200 conforms to the standards for an MTP connector plug.

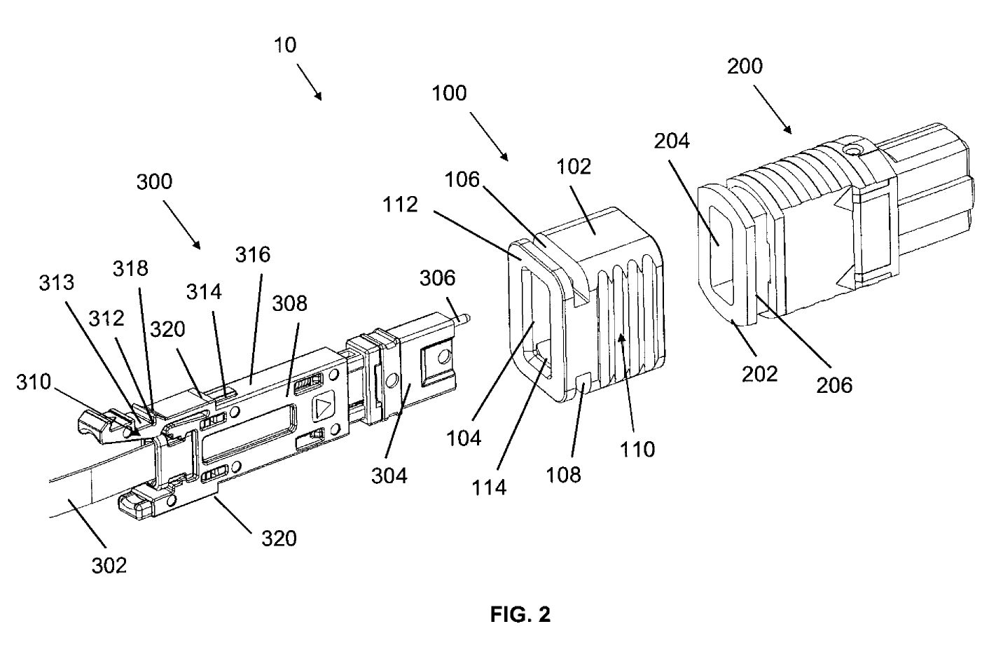

Referring to FIG. 2, the mating unit 10 is shown in an exploded view. The ferrule carrier 300 includes a fiber optic cable 302, the multi-fiber ferrule 304 that terminates the fiber optic cable 302, an alignment member 306 extending from the ferrule 304, a carrier body 308 to support the cable 302 and the ferrule 304, a flexible latch support member 310 disposed on a side surface 316 of the carrier body 308, a latch 312 disposed on the flexible latch support member 310, a groove 313 formed near the rear of the latch 312, and a key 314 disposed on the carrier body 308. In the embodiment shown, the ferrule carrier 300 is a ferrule carrier of the type described in the '016 patent to Roth et al., the entire disclosure of which is incorporated herein by reference.

The fiber optic cable 302 can be a ribbon cable, a circular cable, or any other suitable cable. The optical fiber cable 302 includes optical fibers (not shown) that are received in and coupled to the multi-fiber ferrule 304. The ferrule 304 also has at least one alignment member 306 with a substantially elongated cylindrical form extending away from the carrier body 308. The alignment member 306 aligns the ferrule 304 to a mating receptacle (not shown). In the embodiment shown, the alignment member 306 is positioned to one side of the optical fibers and mechanically supported within the carrier body 308 to extend through the ferrule 304.

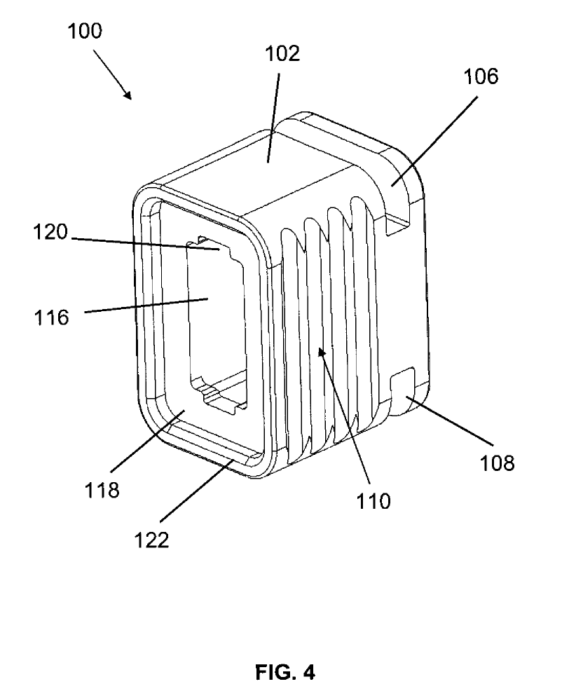

The carrier body 308 has a substantially elongated rectangular form and provides mechanical support to the multi-fiber ferrule 304 and the optical cable 302. The flexible latch support member 310 is disposed on a side surface 316 of the carrier body 308 and elastically flexes away from the carrier body 308. The latch 312 is disposed on the flexible latch support member 310 so that the latch 312 protrudes away from the flexible latch support member 310. Also, the latch 312 has a forward surface 318 that is slanted rearwardly. The groove 313 is near the rear of the latch 312 and formed substantially perpendicular to the longitudinal axis of the carrier body 308. The flexible latch support member 310, the latch 312, and the groove 313 latchably couple the ferrule carrier 300 to the connector sleeve 100. At least one key 314 is disposed on a side surface 316 of the carrier body 308 so as to align the ferrule carrier 300 with the connector sleeve 100. The ferrule carrier 300 is aligned when the key 314 is received by a keyway 120 (shown in FIG. 4) in the connector sleeve 100. Although depicted with a substantially rectangular cross-sectional shape, the key 314 can have any suitable cross-sectional shape, for example, semi-circular, semi-ovular, or polygonal, and accordingly, the keyway 120 would have a corresponding shape to accept the key 314. In the embodiment shown, a shoulder 320 is disposed between the flexible latch support member 310 and the key 314 on the side surface 316, and a second shoulder 320 is disposed on the opposite side. The shoulder 320 prevents the ferrule carrier 300 from completely penetrating the connector sleeve 100 because the forward opening 116 is not sized to allow the shoulder 320 to pass. The shoulder 320 is located on the side surface 316 such that only a predetermined portion of the ferrule carrier 300 extends through the connector sleeve 100 into the connector housing 200.

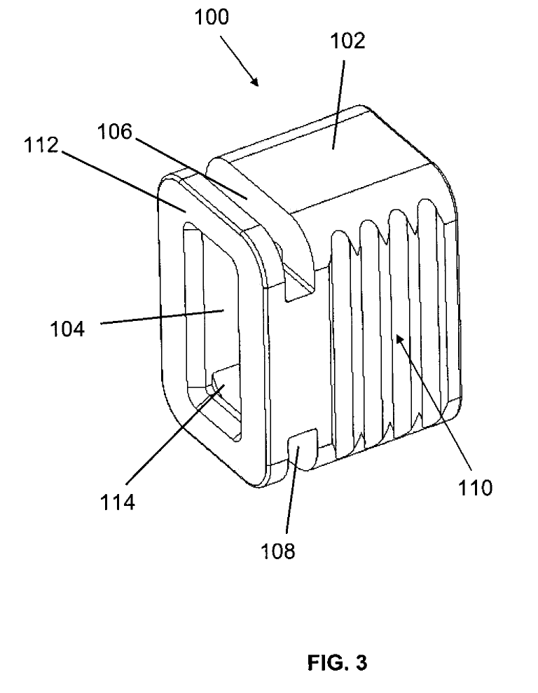

Referring to FIG. 3, the end of the connector sleeve 100 receiving the ferrule carrier 300 is shown. The connector sleeve 100 includes a sleeve body 102, the rear opening 104 at one end of the sleeve body 102, at least one slot 106 and 108 formed on the sleeve body 102, a gripping surface 110 formed on at least one surface of the sleeve body 102, a rear wall 112 formed around the rear opening 104, and an bore 114 extending through the sleeve body 102. Although depicted with a substantially rectangular cross-sectional shape, the sleeve body 102 can have any suitable cross-sectional shape, for example, circular, oval, or polygonal. The connector sleeve 100 can be made of any suitable material that is substantially rigid or substantially semi-rigid. In one embodiment, it is made of plastic, such as ABS simulated plastic. It can also be formed by die casting. The ferrule carrier 300 is adapted to be inserted into a rear opening 104 of the connector sleeve 100 and extends through the connector sleeve 100.

The rear opening 104 of connector sleeve 100 is formed to substantially accept the outermost peripheral dimensions of the ferrule carrier 300. In the embodiment shown, the rear opening 104 has a substantially rectangular form adapted to accept the generally rectangular peripheral shape of the ferrule carrier 300 shown in FIG. 2. The rear opening 104 leads to the bore 114 within the sleeve body 102 of the connector sleeve 100.

At least one slot 106 or 108 is provided on the sleeve body 102 of the connector sleeve 100. The slot 106 or 108 extends from an outer surface of the connector sleeve 100 into the sleeve body 102 to the bore 114. Thus, the slot 106 or 108 forms a ledge on an inner periphery of the bore 114. The slot 106 or 108 is positioned to intercept the latch 312 so that the latch 312 on the ferrule carrier 300 can latchably engage the slot 106 or 108. In the embodiment depicted, two slots 106 and 108 are provided substantially parallel to the rear wall 112 and substantially perpendicular to the bore 114. The number of slots 106 and 108 illustrated is exemplary only and is not intended to be limiting; the optimal number of slots may be less or more than the two slots depicted in FIGS. 1-5.

The slots 106 and 108 together with the latch 312 latchably and removably engage the ferrule carrier 300 to the connector sleeve 100. Although the rear opening 104 of connector sleeve 100 is dimensioned to substantially accept the outermost peripheral dimensions of the ferrule carrier 300, the rear opening 104 is not dimensioned to accept the protruding latch 312 disposed on the flexible latch support member 310, while the flexible latch support member 310 is flexed away from the carrier body 308. Because the latch 312 has a forward surface 318 that is slanted rearwardly, the rearward slant of the latch 312 causes the flexible latch support member 310 to deflect downward as the ferrule carrier 300 is inserted in and through the connector sleeve 100. Therefore, as the ferrule carrier 300 is inserted through the bore 114, the flexible latch support member 310 is forced towards the carrier body 308 by the forward surface 318 of the latch 312 abutting an edge of the rear opening 104 so that the latch 312 can pass through the rear opening 104 with the ferrule carrier 300. As the latch 312 deflects downward and moves through the bore 114 of the connector sleeve 100, the latch 312 encounters the slot 106 or 108 and then springs upward. After springing upward, the groove 313 near the rear of the latch 312 engages the ledge formed by the slot 106 or 108, and thus latchably engages the ferrule carrier 300 to the connector sleeve 100.

To remove the ferrule carrier 300 from the mating unit 10, the flexible latch support member 310 is pressed downward towards the carrier body 308 so that the groove 313 near the rear of the latch 312 disengages from the slot 106 or 108. While the flexible latch support member 310 is pressed, the ferrule carrier 300 is pulled away from the connector sleeve 100 and the connector housing 200.

With the construction described above, the mating unit 10 provides a replacement mating unit that accepts ferrules and conforms to a design of a previously installed mating unit of an optical connector. The connector sleeve 100 allows the mating unit 10 to accept the ferrule carrier 300, and the connector housing 200 is shaped to be received by the counterpart mating unit of the previously installed optical connector. Since the ferrule carrier 300 is removable and can be replaced, a replacement ferrule carrier 300 can be inserted into the same mating unit 10 without replacing the entire mating unit 10. Thus, the ferrule carrier 300 can be removed and inspected, repaired, or replaced without replacing the entire mating unit 10. Furthermore, because the ferrule carrier 300 is removable, the ferrule carrier 300 can be replaced with inspection equipment designed for the previously installed optical connector.

The connector sleeve 100 can also have at least one gripping surface 110. In the embodiment shown, the connector sleeve 100 includes two gripping surfaces 110 on opposing sides of the sleeve body 102. The gripping surface 110 can be, but is not limited to, grooves, ridges, knurls, roughened surfaces, cross-hatching, protrusions, combinations of the aforementioned, or some other structure that aids in the gripping of the connector sleeve 100.

Referring to FIG. 4, an opposite end of the connector sleeve 100 is shown. The connector sleeve 100 has a forward opening 116 which may be shaped to correspond substantially to the outer peripheral shape of the carrier body 302 and key 314 of the ferrule carrier 300. Comparing FIGS. 3 and 4, the forward opening 116 is smaller than the rear opening 104, because while the rear opening 104 is formed to substantially accept the outermost peripheral dimensions of the ferrule carrier 300, the forward opening 116 is formed to substantially accept the outermost peripheral dimensions of the carrier body 302 and the key 314. The forward opening 116 is sized such that the shoulders 320 cannot pass through the forward opening 116, thereby preventing the ferrule carrier 300 from penetrating the connector sleeve 100 any further. This is done to properly align the ferrule carrier 300 within the connector sleeve 100 and the connector housing 200. Also, the key 314 ensures the ferrule 304 is properly aligned with its counterpart in the receptacle. The connector sleeve 100 has a mating surface 118 to mate with a surface 202 (shown in FIG. 2) of the connector housing 200. In the embodiment shown, an annular projection 122 is formed substantially around the outermost periphery of the mating surface 118. The annular projection 122 aligns the connector sleeve 100 with the connector housing 200. Also, the annular projection 122 prevents the connector housing 200 from slipping upwards, downwards, or to the sides relative to the connector sleeve 100.

Returning to FIG. 2, the connector housing 200 includes a surface 202 and a channel 204. The channel 204 is dimensioned to accept the ferrule carrier 300 and extends substantially through the connector housing 200. The surface 202 provides a surface for mating with the mating surface 118 (shown in FIG. 4) of the connector sleeve 100. In some embodiments, a separate connector sleeve 100 is provided to couple with an available and pre-installed connector housing 200.

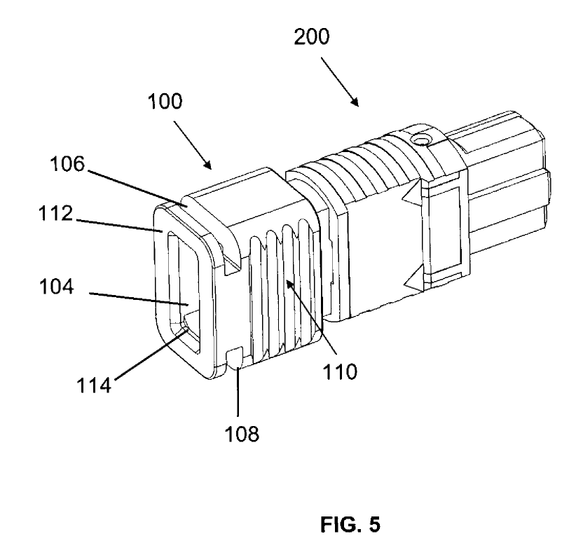

Referring to FIG. 5, the connector sleeve 100 is shown coupled with the connector housing 200. The connector sleeve 100 is coupled to the connector housing 200 by mechanically interlocking parts but can also be connected by other means, such as, but not limited to, adhesives or welding. The connector sleeve 100 is coupled to the connector housing 200 so that the bore 114 and the channel 204 receive the ferrule carrier 300. Also, the forward opening 116 is smaller than the channel 204. In one embodiment, the connector housing 200 is coupled to the connector sleeve 100 by an epoxy, where the mating surface 118 and surface 202 substantially contact each other. In another embodiment, the connector housing 200 is coupled to the connector sleeve 100 by a press fitting, where the peripheral edges 206 of the surface 202 forms a press fitting with the annular projection 122 around mating surface 118. In yet another embodiment, the connector sleeve 100 and connector housing 200 can be formed as a single piece. After the connector sleeve 100 is coupled to the connector housing 200, the ferrule carrier 300 is inserted into the connector sleeve 100 to form the mating unit 10.

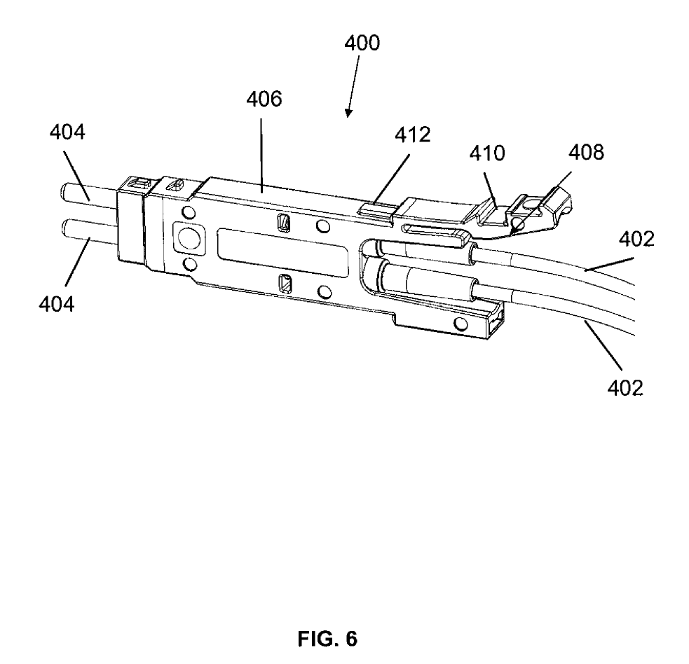

Referring to FIG. 6, a ferrule carrier 400 in accordance with another embodiment is shown. In the embodiment shown, the ferrule carrier 400 is a duplex ferrule carrier. The ferrule carrier 400 includes two fiber optic cables 402, two ferrules 404 that each terminate one of the fiber optic cables 402, a carrier body 406 that mechanically supports the fiber optic cables 402 and ferrules 404, a flexible latch support member 408 disposed on the carrier body 406, a latch 410 disposed on the flexible latch support member 408, and a key 412 disposed on the carrier body 406. Unlike the ferrule carrier 300, the ferrule carrier 400 has two fiber optic cables 402 terminated in two ferrules 404. The ferrules 404 have a substantially elongated cylindrical form that extends away from the carrier body 406. The ferrule carrier 400 is adapted to be inserted into the rear opening 104 of the connector sleeve 100, extend through the connector sleeve 100, and be received substantially in the connector housing 200. The flexible latch support member 408, the latch 410, and the key 412 are substantially similar to the flexible latch support member 310, the latch 312, and the key 314 of the ferrule carrier 300, therefore refer to the detailed description of these components provided above.

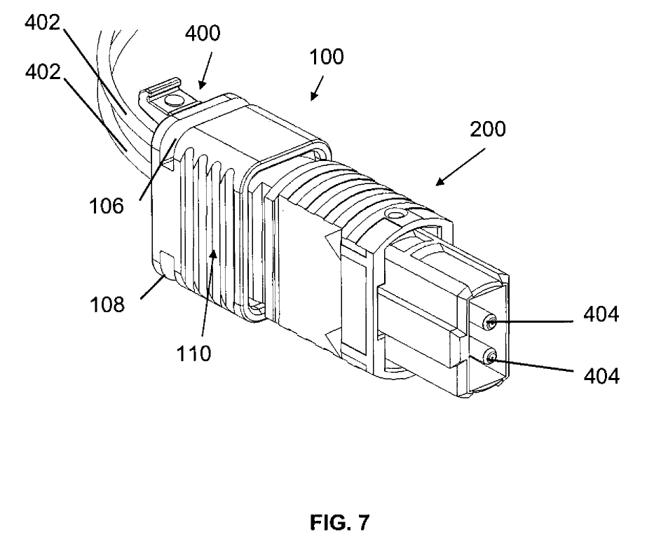

Referring to FIG. 7, the ferrule carrier 400, connector sleeve 100, and connector housing 200 are shown assembled together. The connector housing 200 is coupled to one end of the connector sleeve 100. In the embodiment shown, the connector housing 200 conforms to the design of an MTP connector, similar to FIG. 2. The connector housing 200 is coupled to the connector sleeve 100. The ferrule carrier 400 is inserted into the opposite end of the connector sleeve 100 and extends through the connector sleeve 200 to be received substantially in the connector housing 200. In the embodiment depicted, the ends of the ferrules 404 are flush with the forward end of the connector housing 200 and available to mate with a counterpart receptacle.

As apparent from the above description, the present invention provides a mating unit for an optical connector. The mating unit has a connector sleeve that is coupled to a connector housing, and a ferrule carrier is inserted through the connector sleeve and connector housing. The connector housing substantially conforms to the standards and design for a mating unit previously installed. Since the connector housing conforms to the previously installed mating unit, it can be connected to the previous optical connector's counterpart mating unit. The ferrule carrier is inserted into the connector sleeve opposite the connector housing and removably engages the connector sleeve. Since the ferrule carrier is removable from the connector sleeve, the present invention allows substitution of the ferrule carrier with a replacement ferrule carrier, a modified ferrule carrier, or an inspection device. Accordingly, the mating unit can replace a mating unit of an optical connector already in use. The replacement mating unit allows for repair and replacement of internal components without replacing the entire mating unit or optical connector.

While a particular embodiment has been chosen to illustrate the invention, it will be understood by those skilled in the art that various changes and modifications can be made therein without departing from the scope of the invention as defined in the appended claims.

What is claimed is:

1. A first mating unit for engaging a second mating unit of an optical connector, the first mating unit comprising:
a connector sleeve;
a connector housing coupled to one end of the connector sleeve, the connector housing substantially shaped to mate with the second mating unit; and
a ferrule carrier inserted into the connector sleeve opposite the connector housing and removably engaged to the connector sleeve, the ferrule carrier adapted to couple with an optical fiber cable.

2. The first mating unit of claim 1, further comprising a slot disposed on the connector sleeve.

3. The first mating unit of claim 2, further comprising a latch disposed on the ferrule carrier, the latch removably engaging the slot.

4. The first mating unit of claim 1, further comprising a gripping surface disposed on the connector sleeve.

5. The first mating unit of claim 1, wherein the connector housing substantially conforms to an MTP connector plug.

6. The first mating unit of claim 1, wherein the ferrule carrier is an MT ferrule carrier.

7. The first mating unit of claim 1, wherein the ferrule carrier is a duplex carrier.

8. The first mating unit of claim 1, wherein the connector sleeve and the connector housing are formed together as a single piece.

9. A first mating unit for engaging a second mating unit of an optical connector, the first mating unit comprising:
a connector sleeve with a slot;
a connector housing coupled to one end of the connector sleeve, the connector housing substantially conforming to an MTP connector plug;
a ferrule carrier inserted into the connector sleeve opposite the connector housing, the ferrule carrier adapted to couple with an optical fiber cable; and
a latch disposed on the ferrule carrier, the latch removably engaging the slot of the connector sleeve.

10. The first mating unit of claim 9, further comprising a gripping surface disposed on the connector sleeve.

11. The first mating unit of claim 9, wherein the ferrule carrier is an MT ferrule carrier.

12. The first mating unit of claim 9, wherein the ferrule carrier is a duplex ferrule carrier.

13. The first mating unit of claim 9, wherein the connector sleeve and the connector housing are formed together as a single piece.

14. An optical connector comprising:
a connector sleeve formed together with a connector housing having a shape substantially conforming to a plug of a previously installed optical connector, the connector housing received by a receptacle for the previously installed optical connector; and
a ferrule carrier inserted into the connector sleeve opposite the connector housing, the ferrule carrier adapted to couple with an optical fiber cable.

15. The optical connector of claim 14, further comprising a slot disposed on the connector sleeve.

16. The optical connector of claim 15, further comprising a latch disposed on the ferrule carrier, the latch removably engaging the slot.

17. The optical connector of claim 14, further comprising a gripping surface disposed on the connector sleeve.

18. The optical connector of claim 14, wherein the connector housing substantially conforms to an MTP connector plug.

19. The optical connector of claim 14, wherein the ferrule carrier is an MT ferrule earner.

20. The optical connector of claim 14, wherein the ferrule carrier is a duplex ferrule carrier.
